(19) United States
(12) Patent Application Publication
(10) Pub. No.: US 2007/0046407 A1
(43) Pub. Date: Mar. 1, 2007

(54) Sheet magnetizer systems and methods thereof

(75) Inventor: Ferris Arnold, Marietta, OH (US)

Correspondence Address: NIXON PEABODY LLP - PATENT GROUP, CLINTON SQUARE, P.O. BOX 31051, ROCHESTER, NY, 14603-1051, US

(73) Assignee: Arnold Magnetic Technologies, Rochester, NY (US)

(21) Appl. No.: 11/384,906

(22) Filed: Mar. 20, 2006

Related U.S. Application Data
(60) Provisional application No. 60/663,810, filed on Mar. 21, 2005.

(51) Int. Cl. H01F 13/00

(52) U.S. Cl. 335/284

(57) ABSTRACT

A sheet magnetizer system and a method thereof includes a first set of one or more magnetized elements which are mounted on a first shaft for rotational movement and a second set of one or more magnetized elements which are mounted on a second shaft for rotational movement. One or more of the first set of magnetized elements are in an offset configuration with one or more of the second set of magnetized elements.

This application claims the benefit of U.S. Provisional Patent Application Ser. No. 60/663,810, filed Mar. 21, 2005, which is herein incorporated by reference in its entirety.

### FIELD OF THE INVENTION

The present invention generally relates to magnetizers and, more particularly, to sheet magnetizer systems and methods thereof.

### BACKGROUND

With the increase in low-cost, high-quality, minimum set-up, printing technologies, commercial printers and the general public have expressed an interest in being able to print artwork or photos onto a “magnetic sheet.” With the magnetic sheet, the artwork or photo easily can be magnetically secured to a refrigerator, file cabinet, or other magnetic receptive surface for display.

Unfortunately, a magnetically receptive sheet which is magnetized can not be run through a printer because once magnetized the magnetic sheet will stick to metal parts in the printer. Accordingly, the magnetically receptive sheet must be magnetized after the artwork or photo has been printed on the magnetically receptive sheet.

Currently, there are no effective systems for magnetizing a magnetically receptive sheet after printing. Typically, existing systems use a separator between the magnetically receptive sheet and magnetizer which helps to prevent the two from sticking together. However, the separator also reduces the effectiveness of the magnetization and slows down the magnetization process.

### SUMMARY

A sheet magnetizer system in accordance with embodiments of the present invention includes a first set of one or more magnetized elements which are mounted on a first shaft for rotational movement and a second set of one or more magnetized elements which are mounted on a second shaft for rotational movement. One or more of the first set of magnetized elements are in an offset configuration with one or more of the second set of magnetized elements.

A method of making a sheet magnetizer system in accordance with other embodiments of the present invention includes mounting a first set of one or more magnetized elements on a first shaft for rotational movement, mounting a second set of one or more magnetized elements on a second shaft for rotational movement, and arranging one or more of the first set of magnetized elements in an offset configuration with one or more of the second set of magnetized elements.

A sheet magnetizer system in accordance with other embodiments of the present invention includes at least two shafts with offsetting magnetized rollers in at least a partially, nested configuration and at least one shaft with offsetting non-magnetized rollers in at least a partially, nested configuration with the magnetized rollers on one of the at least two shafts.

A method of making a sheet magnetizer system in accordance with other embodiments of the present invention includes arranging at least two shafts with offsetting magnetized rollers in at least a partially, nested configuration and arranging at least one shaft with offsetting non-magnetized rollers in at least a partially, nested configuration with the magnetized rollers on one of the at least two shafts.

A sheet magnetizer system in accordance with other embodiments of the present invention includes a handheld housing, one or more magnetized elements, and one or more non-magnetized elements. The one or more magnetized elements are fixed within the handheld housing along at least one surface. The one or more non-magnetized elements are mounted in the housing along the at least one surface at least one of upstream from the one or more magnetized elements and downstream from the one or more magnetized elements.

The present invention provides a system and method for quickly, easily, and effectively magnetizing a magnetically receptive sheet after printing. As a result, the present invention allows a printer or other commercial or lay person, to expand the use of their existing printing equipment to include the market of magnetically receptive material.

The present invention utilizes a spaced apart and offset configuration of magnetic elements which helps to prevent a magnetically receptive sheet from sticking to the magnetizer while still effectively magnetizing the magnetically receptive sheet. The addition of other spaced apart and offset non-magnetic elements helps to further prevent a magnetically receptive sheet from sticking to the magnetizer. Additionally, the present invention eliminates the need and cost of using a separator during the magnetization process and also improves the effectiveness of the magnetization process.

### BRIEF DESCRIPTION OF THE DRAWINGS

FIG. 1A is a top view of a sheet magnetizer in accordance with embodiments of the present invention;

FIG. 1B is a side view of the sheet magnetizer shown in FIG. 1A;

FIG. 1C is a top view of a magnetic roller shown in FIG. 1A;

FIG. 2A is a top view of another embodiment of a portion of a sheet magnetizer;

FIG. 2B is a top view of yet another embodiment of a portion of a sheet magnetizer

FIG. 3A is a bottom view of a handheld sheet magnetizer;

FIG. 3B is a side view of the handheld sheet magnetizer shown in FIG. 3A; and

FIG. 4 is bottom view of another handheld sheet magnetizer.

### DETAILED DESCRIPTION

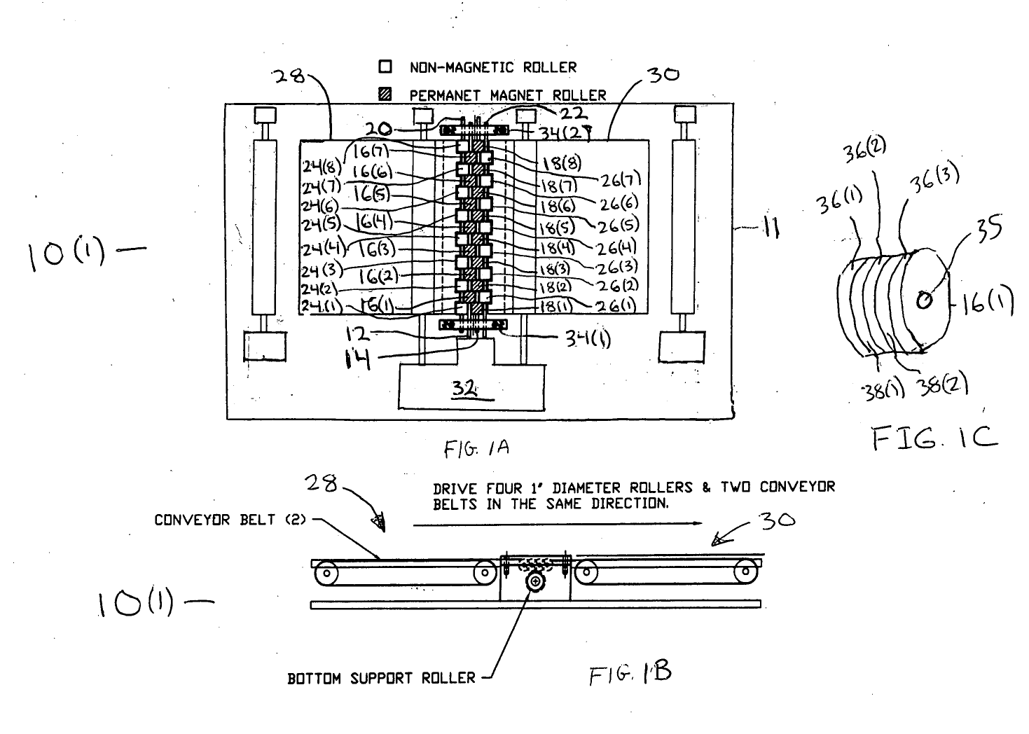

A sheet magnetizer system 10 in accordance with embodiments of the present invention is illustrated in FIGS. 1A-1B. The sheet magnetizer system includes shafts 12 and 14 with magnetic rollers 16(1)-16(7) and 18(1)-18(8) respectively, shafts 20 and 22 with non-magnetic rollers 24(1)-24(8) and 26(1)-26(7) respectively, a feeder system 28, a take-off system 30, and a drive system 32, although the sheet magnetizer system 10 can have other numbers and types of components and elements in other configurations. The present invention provides a number of advantages including providing a system and method for quickly, easily, and effectively magnetizing a magnetically receptive sheet.

Referring to FIG. 1A, magnetic rollers 16(1)-16(7) are equidistantly spaced apart and mounted on the shaft 12 for rotational movement and the magnetic rollers 18(1)-18(8) are equidistantly spaced apart and mounted on the shaft 14 for rotational movement, although other numbers and types of magnetic elements in other spacing arrangements can be used. In these particular embodiments, the magnetic rollers 16(1)-16(7) and magnetic rollers 18(1)-18(8) are arranged so that there is an equivalent amount of empty space equal to the width of one of the magnetized rollers between each one of the magnetic rollers 16(1)-16(7) and magnetic rollers 18(1)-18(8), although again other spacing arrangements could be used.

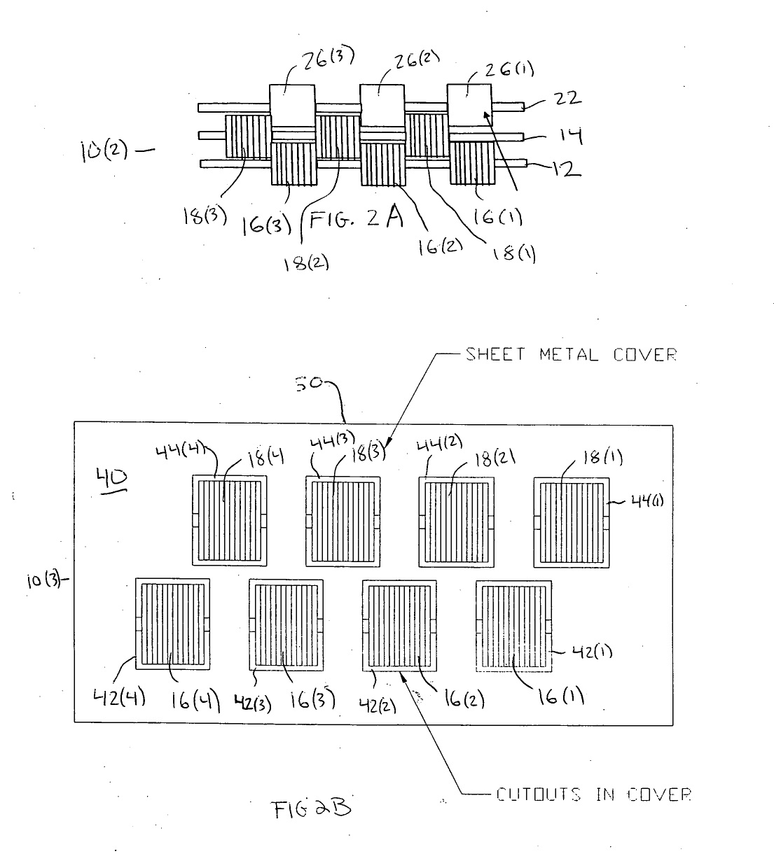

One end of the shaft 12 and one end of shaft 14 are mounted in a bearing housing 34(1) for rotational movement and the opposing end of the shaft 12 and opposing end of shaft 14 are mounted in a bearing housing 34(2), although other manners for mounting the shafts 12 and 14 could be used. The shafts 12 and 14 are mounted in the bearing housings 34(1) and 34(2) in the housing 11 so that magnetic rollers 16(1)-16(7) are partially nested between magnetic rollers 18(1)-18(8), although other configurations or arrangements could be used, such as an offset configuration as shown in FIG. 2B.

More specifically as shown in FIG. 1, in these particular embodiments the magnetic roller 16(1) is partially nested between magnetic rollers 18(1) and 18(2), magnetic roller 16(2) is partially nested between magnetic rollers 18(2) and 18(3), magnetic roller 16(3) is partially nested between magnetic rollers 18(3) and 18(4), magnetic roller 16(4) is partially nested between magnetic rollers 18(4) and 18(5), magnetic roller 16(5) is partially nested between magnetic rollers 18(5) and 18(6), magnetic roller 16(6) is partially nested between magnetic rollers 18(6) and 18(7), magnetic roller 16(7) is partially nested between magnetic rollers 18(7) and 18(8), although again other arrangements could be used. This offset and partially nested configuration for the magnetic rollers 16(1)-16(7) and the magnetic rollers 18(1)-18(8) helps to keep a magnetically receptive sheet from wrapping around in the magnetizer system yet it allows for direct contract for the magnetization process.

Referring to FIG. 1C, the magnetic roller 16(1) has a substantially circular shape with an opening 35 for mounting on the shaft 12, although the magnetic roller 16(1) can have other shapes and can be mounted in other manners. Additionally, the magnetic roller 16(1) comprises an alternating series of magnetic sections 36(1)-36(3), such as neodymium by way of example only, and conductive elements 38(1)-38(2), such as steel washers by way of example only, although the magnetic roller 16(1) can comprise other numbers and types of elements in other arrangements, such as a one piece magnet. The combination of alternating magnetic sections 36(1)-36(3) and conductive elements 38(1)-38(2) creates a strong magnetic circuit by focusing the flux of the magnet to the surface of the magnetic roller 16(1). In these particular embodiments the other magnetic rollers 16(2)-16(7) and 18(1)-18(8) are the same as the magnetic roller 16(1), although one or more of the magnetic rollers 16(2)-16(7) and 18(1)-18(8) could be comprised of other types and numbers of elements in other configurations, such as a one piece magnet.

Non-magnetic rollers 24(1)-24(8) are equidistantly spaced apart and mounted on the shaft 20 for rotational movement and the non-magnetic rollers 26(1)-26(7) are equidistantly spaced apart and mounted on the shaft 22 for rotational movement, although other numbers and types of magnetic elements in other spacing arrangements can be used. One end of the shaft 20 and one end of shaft 22 are mounted in the bearing housing 34(1) for rotational movement and the opposing end of the shaft 20 and opposing end of shaft 22 are mounted in a bearing housing 34(2), although other manners for mounting the shafts 20 and 22 could be used.

The shaft 20 is mounted in the bearing housings 34(1) and 34(2) in the housing 11 so non-magnetic rollers 24(1)-24(8) are partially nested between magnetic rollers 16(1)-16(7) and shaft 22 is mounted in the bearing housings 34(1) and 34(2) in the housing 11 so non-magnetic rollers 26(1)-26(7) are partially nested between magnetic rollers 18(1)-18(7), although other nesting configurations or arrangements could be used. More specifically, in these particular embodiments magnetic roller 16(1) is partially nested between non-magnetic rollers 24(1) and 24(2), magnetic roller 16(2) is partially nested between non-magnetic rollers 24(2) and 24(3), magnetic roller 16(3) is partially nested between non-magnetic rollers 24(3) and 24(4), magnetic roller 16(4) is partially nested between non-magnetic rollers 24(4) and 24(5), magnetic roller 16(5) is partially nested between non-magnetic rollers 24(5) and 24(6), magnetic roller 16(6) is partially nested between non-magnetic rollers 24(6) and 24(7), and magnetic roller 16(7) is partially nested between non-magnetic rollers 24(7) and 24(8), although again other arrangements could be used.

Additionally, in these particular embodiments non-magnetic roller 26(1) is partially nested between magnetic rollers 18(1) and 18(2), non-magnetic roller 16(2) is partially nested between magnetic rollers 18(2) and 18(3), non-magnetic roller 16(3) is partially nested between magnetic rollers 18(3) and 18(4), non-magnetic roller 16(4) is partially nested between magnetic rollers 18(4) and 18(5), non-magnetic roller 16(5) is partially nested between magnetic rollers 18(5) and 18(6), non-magnetic roller 16(6) is partially nested between magnetic rollers 18(6) and 18(7), and non-magnetic roller 16(7) is partially nested between magnetic rollers 18(7) and 18(8), although other combination of sets of magnetized and non-magnetized rollers and other types of non-magnetic devices, such as non-magnetic fingers could be used for the non-magnetized rollers.

Referring to FIGS. 1A and 1B, the feeder system 28 is positioned upstream from and is used to feed a magnetically receptive sheet to the magnetic rollers 16(1)-16(7) and the magnetic rollers 18(1)-18(8), although other manners for directing a magnetically receptive sheet over the magnetic rollers 16(1)-16(7) and the magnetic rollers 18(1)-18(8) could be used. In these particular embodiments, the feeder system 28 comprises a conveyor belt system which allows for continuous feeding, although other types of conveying systems could be used. Additionally, a take-off system 30 is positioned downstream from and is used to transport a magnetically receptive sheet away from the magnetic rollers 16(1)-16(7) and the magnetic rollers 18(1)-18(8), although other manners for transporting a magnetically receptive sheet away from the magnetic rollers 16(1)-16(7) and the magnetic rollers 18(1)-18(8) could be used. In these particular embodiments, the take-off system 30 also comprises a conveyor belt system, although other types of conveying systems could be used.

A driving system 32 is coupled to rotate the shaft 12 with the magnetized rollers 16(1)-16(7) and shaft 22 with the non-magnetized rollers 26(1)-26(7) to move a magnetically receptive sheet over them, although the driving system 32 could be coupled to other numbers and types of shafts, such as shaft 14 with magnetic rollers 18(1)-18(8) or to shaft 20 with non-magnetic rollers 24(1)-24(8) or the driving system 32 may not be connected to any of the shafts 12, 14, 20, and 22. Additionally, the driving system 32 is coupled to drive the rotation of the feeder system 28 and the take-off system 30, although other arrangements could be used.

Referring to FIG. 2A, a portion of another sheet magnetizer system 10(2) in accordance with other embodiments of the present invention is illustrated. The sheet magnetizer system 10(2) is identical to the sheet magnetizer system 10(1), except as set forth below. In these embodiments for the sheet magnetizer system 10(2), magnetic rollers 16(1)-16(3) are equidistantly spaced apart and mounted on the shaft 12 for rotational movement, magnetic rollers 18(1)-18(3) are equidistantly spaced apart and mounted on the shaft 14 for rotational movement, and non-magnetic rollers 26(1)-26(3) are equidistantly spaced apart and mounted on the shaft 22 for rotational movement, although other numbers and types of elements in other arrangements could be used. Additionally, in these particular embodiments the magnetic rollers 16(1)-16(3) are in a partially nested configuration with magnetic rollers 18(1)-18(3) which are in a partially nested configuration with non-magnetic rollers 24(1)-24(3), although other configurations for the magnetic and non-magnetic elements could be used, such as one or more offset configurations.

Referring to FIG. 2B-2C, a portion of another sheet magnetizer system 10(3) in accordance with other embodiments of the present invention is illustrated. The sheet magnetizer system 10(3) is identical to the sheet magnetizer system 10(1), except as set forth below. In these embodiments for the sheet magnetizer system 10(3), in a housing 50 magnetic rollers 16(1)-16(4) are equidistantly spaced apart and mounted on a shaft for rotational movement and magnetic rollers 18(1)-18(4) are equidistantly spaced apart and mounted on another for rotational movement, although other numbers and types of elements in other arrangements could be used. The housing 50 has a surface 40 with rectangular-shaped openings 42(1)-42(4) and rectangular-shaped openings 44(1)-44(4) arranged in an offset configuration, although the surface 40 could have other numbers and types of openings in other shapes and arrangements. The magnetic rollers 16(1)-16(4) are each positioned in the housing 50 to extend partially from one of the openings 42(1)-42(4) and the magnetic rollers 18(1)-18(4) are each positioned in the housing 50 to extend partially from one of the openings 44(1)-44(4), although the other arrangements could be used. The surface 40 of the housing 50 is made out of a non-magnetic material to help prevent a magnetically receptive sheet which is being magnetized from sticking to any of the magnetic rollers 16(1)-16(4) and the magnetic rollers 18(1)-18(4).

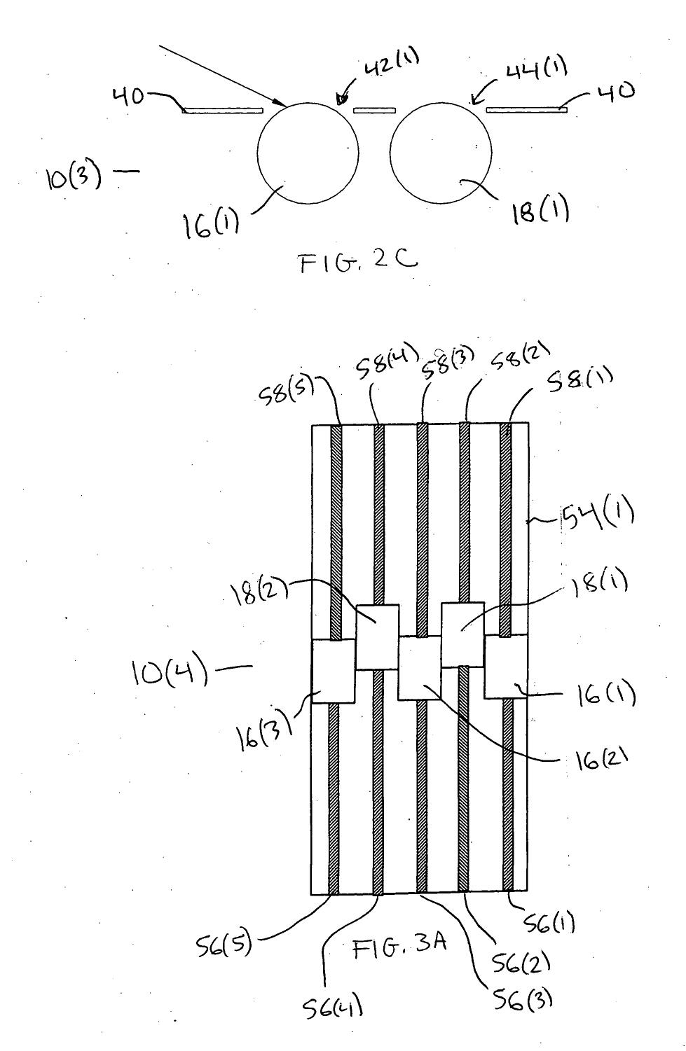

Referring to FIGS. 3A-3B, a portion of another sheet magnetizer system 10(4) in accordance with other embodiments of the present invention is illustrated. The sheet magnetizer system 10(4) is identical to the sheet magnetizer system 10(1), except as set forth below. In these embodiments, the sheet magnetizer system 10(4) has a handheld housing 52 with a bottom surface 54(1). In the handheld housing 52, magnetic rollers 16(1)-16(3) are equidistantly spaced apart and mounted on a shaft for rotational movement and magnetic rollers 18(1)-18(2) are equidistantly spaced apart and mounted on another for rotational movement, although other numbers and types of elements in other arrangements could be used. The housing 50 has a surface 54(1) with non-magnetic ribs or fingers 56(1)-56(5) which extend out away from the surface 54(1) upstream from magnetic rollers 16(1)-16(3) and magnetic rollers 18(1)-18(2) and non-magnetic ribs or fingers 58(1)-58(5) which extend out away from the surface 54(1) downstream from magnetic rollers 16(1)-16(3) magnetic rollers 18(1)-18(2), although the surface 54(1) could have other numbers and types elements in other arrangements. In these particular embodiments, the handheld housing 52 has a partially circular, cross-sectional shape, although the housing 52 could have other shapes.

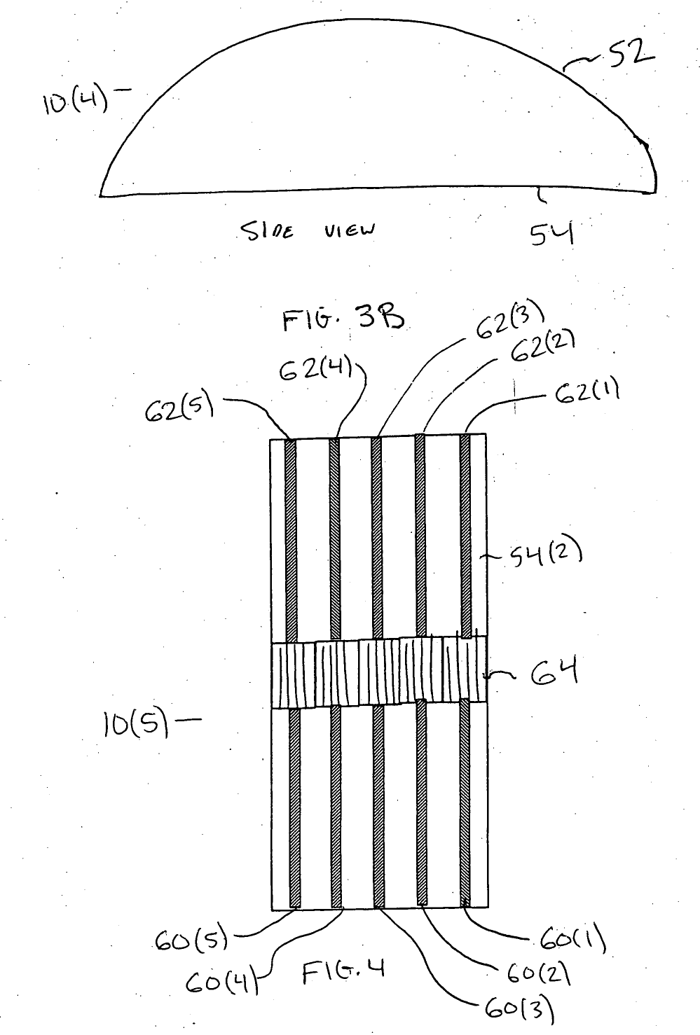

Referring to FIG. 4, a portion of another sheet magnetizer system 10(5) in accordance with other embodiments of the present invention is illustrated. The sheet magnetizer system 10(5) is identical to the sheet magnetizer system 10(1), except as set forth below. In these embodiments, the sheet magnetizer system 10(4) also has a handheld housing, like the one shown in FIG. 3B, except with a bottom surface 54(2). Along the bottom surface 54(2), a magnetic device 64 comprising an alternating series of magnetic elements and conductive elements is fixed in the housing along the surface 54(2), although other numbers and types of magnetic elements in other arrangements could be used, such as one piece magnetic device. Non-magnetic ribs or fingers 60(1)-60(5) which extend out away from the surface 54(2) upstream from magnetic device 64 and non-magnetic ribs or fingers 62(1)-62(5) which also extend out away from the surface 54(2) downstream from magnetic device 64, although the surface 54(2) could have other numbers and types elements in other arrangements.

The operation of the sheet magnetizer system 10(1) will now be described with reference to FIGS. 1A-1B. The drive system 32 is engaged to drive the feeder system 28, shafts 12 and 22, and the take-off system 30, although the drive system 32 can be connected to drive other numbers and/or combinations of elements and other types and combinations of drive systems could be used. Next, a sheet of magnetically receptive material is placed on the feeder system 28 and is fed towards the magnetic rollers 16(1)-16(7) and the magnetic rollers 18(1)-18(8) and the non-magnetic rollers 24(1)-24(8) and 26(1)-26(7).

When the sheet of magnetically receptive material is fed over the magnetic rollers 16(1)-16(7) and the magnetic rollers 18(1)-18(8), the sheet is in direct contact with the magnetization source and thus can be easily and effectively magnetized. With the magnetic rollers 16(1)-16(7) partially nested between magnetic rollers 18(1)-18(8) in an offset arrangement, the sheet of magnetically receptive material can be magnetized without any issues of adhering to and wrapping around the magnetizing rollers. Additionally, the use of non-magnetic rollers 24(1)-24(8) which are partially nested between magnetic rollers 16(1)-16(7) and shaft 22 and non-magnetic rollers 26(1)-26(7) which are partially nested between magnetic rollers 18(1)-18(7) helps to further prevent any of the prior problems with adhering to and wrapping around the magnetizing rollers.

The take-off system 30 receives the sheet of magnetically receptive material which has now been magnetized and removes the magnetized sheet from the system. With the present invention, the sheet of magnetically receptive material can be printed on ahead of time and then can be effectively magnetized. The sheet magnetizer system 10(1) is easy to use and very reliable.

The operation of the sheet magnetizer system 10(2) is identical to the operation of the sheet magnetizer system 10(1), except that only one set of non-magnetic rollers 26(1)-26(3) is used. Nevertheless, with the magnetic rollers 16(1)-16(3) partially nested between magnetic rollers 18(1)-18(3) in an offset arrangement and the use of non-magnetic rollers 26(1)-26(3) which are partially nested between magnetic rollers 18(1)-18(3) helps to further prevent any of the prior problems with adhering to and wrapping around the magnetizing rollers.

Similarly, the operation of the sheet magnetizer system 10(3) is identical to the operation of the sheet magnetizer system 10(1), except that magnetic rollers 16(1)-16(4) are offset with, but are not partially nested between magnetic rollers 18(1)-18(4) and the non-magnetic rollers have been replaced by a non-magnetic surface 40 with openings 42(1)-42(4) for the magnetic rollers 16(1)-16(3) and openings 44(1)-44(4) for the magnetic rollers 18(1)-18(4). Again, with the magnetic rollers 16(1)-16(4) offset from the magnetic rollers 18(1)-18(4) and the use of non-magnetic surface 40 also helps to further prevent any of the prior problems with adhering to and wrapping around the magnetizing rollers.

The operation of the sheet magnetizer system 10(4) is identical to the operation of the sheet magnetizer system 10(1), except that the system 10(4) is handheld and the non-magnetic rollers have been replaced upstream with and non-magnetic ribs or fingers 56(1)-56(5) and downstream with non-magnetic ribs or fingers 58(1)-58(5). Additionally, instead of a feeder system 30 supplying the magnetically receptive sheet, the magnetic rollers 16(1)-16(3) are passed over the magnetically receptive sheet with this handheld system 10(4). With the magnetic rollers 16(1)-16(3) partially nested between magnetic rollers 18(1)-18(2) in an offset arrangement and the use of non-magnetic ribs or fingers 56(1)-56(5) and non-magnetic ribs or fingers 58(1)-58(5) upstream and downstream helps to further prevent any of the prior problems with adhering to and wrapping around the magnetizing rollers.

Similarly, the operation of the sheet magnetizer system 10(5) is identical to the operation of the sheet magnetizer system 10(1), except that the system 10(5) also is handheld and the non-magnetic rollers have been replaced upstream with and non-magnetic ribs or fingers 60(1)-60(5) and downstream with non-magnetic ribs or fingers 62(1)-62(5). Again, instead of a feeder system 30 supplying the magnetically receptive sheet, the fixed magnetic device 64 is passed over the magnetically receptive sheet with this handheld system 10(5). With the non-magnetic ribs or fingers 60(1)-60(5) and non-magnetic ribs or fingers 62(1)-62(5) upstream and downstream helps to further prevent any of the prior problems with adhering to and wrapping around the magnetizing rollers

Accordingly, the present invention provides a sheet magnetizer which has an offset magnetic roller system to keep sheets of magnetically receptive material from wrapping around the magnetizer while allowing direct contract with the magnetization source. Additionally, the present invention provides an easy and effective way to magnetize material which has already been printed. The present invention is able to provide a high throughput for magnetizing sheets of magnetically receptive material.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A sheet magnetizer system comprising:
a first set of one or more magnetized elements which are mounted on a first shaft for rotational movement; and
a second set of one or more magnetized elements which are mounted on a second shaft for rotational movement, wherein one or more of the first set of magnetized elements are in an offset configuration with one or more of the second set of magnetized elements.

2. The system as set forth in claim 1 wherein the offset configuration further comprises one or more of the first set of magnetized elements in at least a partially, nested configuration with one or more of the second set of magnetized elements.

3. The system as set forth in claim 1 further comprising a third set of one or more non-magnetized elements which are in an offset configuration with one of the first set of magnetized elements and the second set of magnetized elements.

4. The system as set forth in claim 3 wherein the offset configuration further comprises one or more of the third set of non magnetized elements in at least a partially, nested configuration with one of the first set of magnetized elements and the second set of magnetized elements.

5. The system as set forth in claim 3 wherein the one or more non-magnetized elements in the third set are mounted on a third shaft for rotational movement.

6. The system as set forth in claim 5 further comprising a fourth set of one or more non-magnetized elements which are in an offset configuration with the other one of the first set of magnetized elements and the second set of magnetized elements.

7. The system as set forth in claim 6 wherein the one or more non-magnetized elements in the fourth set are mounted on a fourth shaft for rotational movement.

8. The system as set forth in claim 7 further comprising a drive system coupled to at least one of the first shaft, the second shaft, the third shaft, and the fourth shaft.

9. The system as set forth in claim 1 wherein one or more of the magnetized elements in at least one of the first set and the second set comprises one or more conductive components adjacent one or more magnetic components.

10. The system as set forth in claim 1 further comprising a feeder system positioned adjacent and upstream of the first set of magnetized roller and the second set of magnetized elements.

11. The system as set forth in claim 10 further comprising a take-off system positioned adjacent and downstream of the first set of magnetized roller and the second set of magnetized elements.

12. The system as set forth in claim 11 further comprising a drive system coupled to at least one of the feeder system and the take-off system.

13. The system as set forth in claim 1 further comprising a handheld housing which is attached to the first set of magnetized elements and the second set of magnetized elements.

14. A method of making a sheet magnetizer system, the method comprising:
mounting a first set of one or more magnetized elements on a first shaft for rotational movement;
mounting a second set of one or more magnetized elements on a second shaft for rotational movement; and
arranging one or more of the first set of magnetized elements in an offset configuration with one or more of the second set of magnetized elements.

15. The method as set forth in claim 14 wherein the offset configuration further comprises one or more of the first set of magnetized elements in at least a partially, nested configuration with one or more of the second set of magnetized elements.

16. The method as set forth in claim 14 further comprising mounting a third set of one or more non-magnetized elements an offset configuration with one of the first set of magnetized elements and the second set of magnetized elements.

17. The method as set forth in claim 16 wherein the offset configuration further comprises one or more of the third set of non magnetized elements in at least a partially, nested configuration with one of the first set of magnetized elements and the second set of magnetized elements.

18. The method as set forth in claim 16 wherein the one or more non-magnetized elements in the third set are mounted on a third shaft for rotational movement.

19. The method as set forth in claim 18 further comprising mounting a fourth set of one or more non-magnetized elements in an offset configuration with the other one of the first set of magnetized elements and the second set of magnetized elements.

20. The method as set forth in claim 19 wherein the one or more non-magnetized elements in the fourth set are mounted on a fourth shaft for rotational movement.

21. The method as set forth in claim 20 further comprising coupling a drive system to at least one of the first shaft, the second shaft, the third shaft, and the fourth shaft.

22. The method as set forth in claim 14 wherein one or more of the magnetized elements in at least one of the first set and the second set comprises one or more conductive components adjacent one or more magnetic components.

23. The method as set forth in claim 14 further comprising positioning a feeder system adjacent and upstream of the first set of magnetized roller and the second set of magnetized elements.

24. The method as set forth in claim 23 further comprising positioning a take-off system adjacent and downstream of the first set of magnetized roller and the second set of magnetized elements.

25. The method as set forth in claim 24 further comprising coupling a drive system to at least one of the feeder system and the take-off system.

26. The method as set forth in claim 14 further comprising a handheld housing which is attached to the first set of magnetized elements and the second set of magnetized elements.

27. A sheet magnetizer system comprising:
at least two shafts with offsetting magnetized rollers in at least a partially, nested configuration; and
at least one shaft with offsetting non-magnetized rollers in at least a partially, nested configuration with the magnetized rollers on one of the at least two shafts.

28. The system as set forth in claim 27 further comprising another shaft with offsetting non-magnetized rollers nested in at least a partially, nested configuration with the magnetized rollers on the other one of the at least two shafts.

29. The system as set forth in claim 27 further comprising a drive system coupled to at least one of the shafts with offsetting magnetized rollers.

30. The system as set forth in claim 27 wherein at least one of the magnetized rollers comprises a series of one or more conductive elements and one or more magnetic elements.

31. The system as set forth in claim 27 further comprising a feeder system positioned adjacent and upstream of the shafts with offsetting magnetized rollers.

32. The system as set forth in claim 31 further comprising a drive system coupled to the feeder system.

33. The system as set forth in claim 27 further comprising a take-off system positioned adjacent and downstream of the shafts with offsetting magnetized rollers.

34. The system as set forth in claim 33 further comprising a drive system coupled to the take-off system.

35. The system as set forth in claim 27 further comprising a handheld housing which is attached to the at least two shafts with offsetting magnetized rollers and the at least one shaft with offsetting non-magnetized rollers.

36. A method of making a sheet magnetizer system, the method comprising:
arranging at least two shafts with offsetting magnetized rollers in at least a partially, nested configuration; and
arranging at least one shaft with offsetting non-magnetized rollers in at least a partially, nested configuration with the magnetized rollers on one of the at least two shafts.

37. The method as set forth in claim 36 further comprising arranging another shaft with offsetting non-magnetized rollers nested in at least a partially, nested configuration with the magnetized rollers on the other one of the at least two shafts.

38. The method as set forth in claim 37 further comprising coupling a drive system to at least one of the shafts with offsetting magnetized rollers.

39. The method as set forth in claim 36 wherein at least one of the magnetized rollers comprises a series of one or more conductive elements and one or more magnetic elements.

40. The method as set forth in claim 36 further comprising positioning a feeder system adjacent and upstream of the shafts with offsetting magnetized rollers.

41. The method as set forth in claim 40 further comprising coupling a drive system to the feeder system.

42. The method as set forth in claim 36 further comprising positioning a take-off system adjacent and downstream of the shafts with offsetting magnetized rollers.

43. The method as set forth in claim 35 further comprising coupling a drive system to the take-off system.

44. The method as set forth in claim 1 further comprising attaching a handheld housing to the at least two shafts with offsetting magnetized rollers and the at least one shaft with offsetting non-magnetized rollers.

45. A sheet magnetizer system comprising:
a handheld housing;
one or more magnetized elements which are fixed within the handheld housing along at least one surface; and
one or more non-magnetized elements which are mounted in the housing along the at least one surface at least one of upstream from the one or more magnetized elements and downstream from the one or more magnetized elements.

46. The system as set forth in claim 45 wherein the one or more non-magnetized elements are mounted along the at least one surface upstream and downstream from the one or more magnetized elements.

47. The system as set forth in claim 45 wherein the one or more non-magnetized elements comprise non-magnetic fingers which extend out away from the at least one surface.
